(19) United States
(12) Patent Application Publication
(10) Pub. No.: US 2021/0154859 A1
(43) Pub. Date: May 27, 2021

(54) ROBOT SYSTEM AND TOOL REPLACEMENT METHOD

(71) Applicant: SEIKO EPSON CORPORATION, Tokyo (JP)

(72) Inventor: Shiguma IIJIMA, SUWA-SHI (JP)

(21) Appl. No.: 16/953,346

(22) Filed: Nov. 20, 2020

(30) Foreign Application Priority Data
Nov. 22, 2019 (JP) 2019-211684

(51) Int. Cl. B25J 13/08; B25J 15/04

(52) U.S. Cl. CPC B25J 13/085; B25J 15/0491; B25J 15/04

(57) ABSTRACT

A robot system includes a robot including a robot arm, a force sensor, and a fitted portion provided at an opposite side to the robot arm via the force sensor, a tool having a fitting portion fitting in the fitted portion, and a control apparatus controlling actuation of the robot, wherein the control apparatus performs first control to detach the tool from the robot arm by driving the robot arm based on output of the force sensor and releasing fitting of the fitted portion and the fitting portion, and second control to attach the tool to the robot arm by driving the robot arm based on the output of the force sensor and fitting the fitted portion in the fitting portion.

The present application is based on, and claims priority from JP Application Serial Number 2019-211684, filed Nov. 22, 2019, the disclosure of which is hereby incorporated by reference herein in its entirety.

### BACKGROUND

### 1. Technical Field

The present disclosure relates to a robot system and tool replacement method.

### 2. Related Art

JP-A-61-293794 discloses an arm for robot having a chuck mechanism including two chuck fingers provided in a distal end portion and a chuck drive unit that opens and closes the chuck fingers. According to the arm for robot, a work may be gripped between the chuck fingers or the chuck fingers may be opened to release the work. Further, according to the arm for robot disclosed in JP-A-61-293794, an arbitrary tool may be gripped in place of the work. In this case, work of replacing the tool gripped by the chuck mechanism by another tool may be performed by driving of the arm for robot.

For example, for the chuck drive unit that drives the chuck mechanism, a mechanism for converting drive energy of electricity, compressed air, or the like into mechanical drive power is required. Generally, the mechanism is heavier in weight. A tool replacement mechanism called “toll changer” is also known, and the mechanism using two plates having higher rigidity is heavier in weight like the above described chuck mechanism.

When the chuck mechanism or tool changer is attached to a robot arm, there is a problem that the weight of the distal end of the robot arm is heavier and weight capacity of the robot arm is restricted.

### SUMMARY

A robot system according to an application example of the present disclosure includes a robot including a robot arm, a force sensor provided in the robot arm, and a fitted portion provided at an opposite side to the robot arm via the force sensor, a tool having a fitting portion fitting in the fitted portion, and a control apparatus controlling actuation of the robot, wherein the control apparatus performs first control to detach the tool from the robot arm by driving the robot arm based on output of the force sensor and releasing fitting of the fitted portion and the fitting portion, and second control to attach the tool to the robot arm by driving the robot arm based on the output of the force sensor and fitting the fitted portion in the fitting portion.

### BRIEF DESCRIPTION OF THE DRAWINGS

FIG. 1 is a perspective view showing a robot system according to a first embodiment.

FIG. 2 is a functional block diagram of the robot system shown in FIG. 1.

FIG. 3 is a block diagram showing an example of a hardware configuration of the robot system shown in FIGS. 1 and 2.

FIG. 4 is a partially enlarged perspective view showing the vicinity of the end effector shown in FIG. 1.

FIG. 5 is a perspective view showing a state in which fitting of a fitted portion and a fitting portion is released in the end effector shown in FIG. 4.

FIG. 6 is a sectional view of FIG. 4.

FIG. 7 is a process chart showing a tool replacement method according to an embodiment.

FIG. 8 is a diagram for explanation of the tool replacement method shown in FIG. 7.

FIG. 9 is a diagram for explanation of the tool replacement method shown in FIG. 7.

FIG. 10 is a diagram for explanation of the tool replacement method shown in FIG. 7.

FIG. 11 is a diagram for explanation of the tool replacement method shown in FIG. 7.

FIG. 12 is a diagram for explanation of the tool replacement method shown in FIG. 7.

FIG. 13 is a diagram for explanation of the tool replacement method shown in FIG. 7.

FIG. 14 is a diagram for explanation of an example of exploring control in two views from different angles arranged one above the other.

FIG. 15 is a diagram for explanation of the example of exploring control in two views from different angles arranged one above the other.

FIG. 16 is a diagram for explanation of the example of exploring control in two views from different angles arranged one above the other.

FIG. 17 is a diagram for explanation of the example of exploring control in two views from different angles arranged one above the other.

FIG. 18 is a diagram for explanation of the example of exploring control in two views from different angles arranged one above the other.

FIG. 19 is a perspective view showing a tool and a tool stocker provided in a robot system according to a second embodiment.

FIG. 20 is a sectional view of the tool and the tool stocker shown in FIG. 19.

FIG. 21 is a partially enlarged perspective view showing the vicinity of an end effector provided in a robot system according to a third embodiment.

### DESCRIPTION OF EXEMPLARY EMBODIMENTS

As below, preferred embodiments of a robot system and tool replacement method according to the present disclosure will be explained in detail according to the accompanying drawings.

### 1. First Embodiment

First, the robot system according to the first embodiment will be explained.

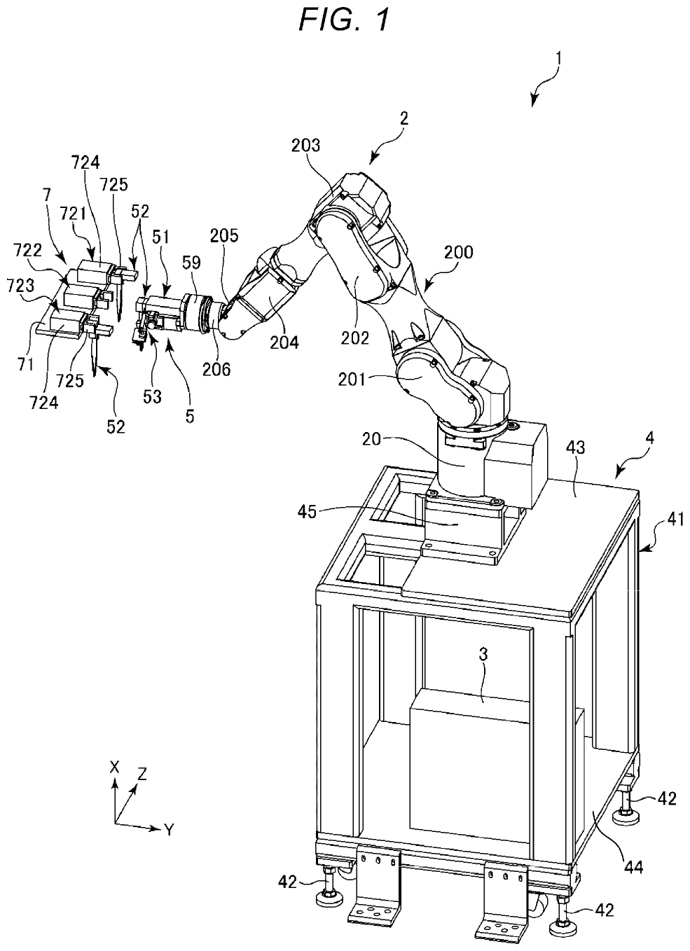

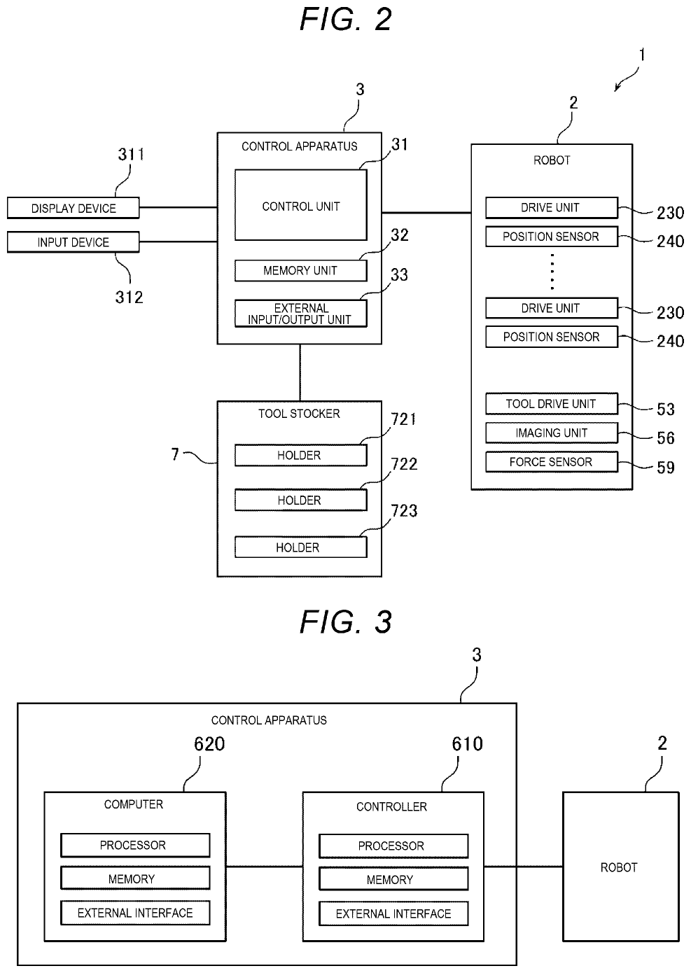

FIG. 1 is the perspective view showing the robot system according to the first embodiment. FIG. 2 is the functional block diagram of the robot system shown in FIG. 1. FIG. 3 is the block diagram showing the example of the hardware configuration of the robot system shown in FIGS. 1 and 2.

Note that, in the respective drawings of this application, an X-axis, a Y-axis, and a Z-axis are set as three axes orthogonal to one another. The Y-axis and the Z-axis are parallel to a horizontal plane and the X-axis is a vertical axis. Further, in the respective drawings, these axes are shown by arrows and the explanation will be made with the pointer sides of the arrows as “plus” and the tail sides as “minus”. Furthermore, the plus side of the X-axis is also referred to as “upper” and the minus side of the X-axis is also referred to as “lower”. In this specification, “plan view” refers to a view along the X-axis from a position along the X-axis.

A robot system 1 shown in FIG. 1 includes a robot 2, a control apparatus 3, a platform 4, tools 52 attached to the robot 2, and a tool stocker 7 for stocking the tools 52.

### 1.1. Robot

The robot 2 shown in FIG. 1 includes a base 20 and a robot arm 200. The robot arm 200 shown in FIG. 1 is a six axis vertical articulated robot arm. The base 20 is fixed to the platform 4, which will be described later.

### 1.1.1. Robot Arm

The robot arm 200 has an arm 201, an arm 202, an arm 203, an arm 204, an arm 205, and an arm 206. These arms 201 to 206 are sequentially coupled from the base 20 side. The respective arms 201 to 206 are pivotable relative to the adjacent arms or the base 20. Note that, in the following description, an end portion of the arm 206 opposite to the arm 205 is referred to as “the distal end of the robot arm 200”.

As shown in FIG. 1, an end effector 5, which will be described later, is coupled to the distal end of the robot arm 200. The end effector 5 includes a tool coupling unit 51 fixed to the distal end of the robot arm 200, a tool 52 attached to the tool coupling unit 51, and a tool drive unit 53 that drives the tool 52. The tool 52 is detachable from the tool coupling unit 51. The tool 52 includes e.g. a gripping hand, suction hand, magnetic hand, screwing tool, and engaging tool. The robot system 1 to which the end effector 5 is coupled may perform work of e.g. feeding, removing, transfer, transport, or assembly of objects.

As shown in FIG. 2, the robot 2 has drive units 230 including motors (not shown) that pivot the arms 201 to 206 and reducers (not shown). The motors include e.g. AC servo motors and DC servo motors. The reducers include e.g. planet-gear reducers and wave gearings. Further, the robot 2 shown in FIG. 2 has position sensors 240. The position sensors 240 detect the rotation angles of the rotation shafts of the motors or the reducers. The drive units 230 and the position sensors 240 are provided in e.g. the base 20 and the respective arms 201 to 206. Further, the drive units 230 can drive the respective arms 201 to 206 independently of one another. Note that the respective drive units 230 and the respective position sensors 240 are respectively coupled communicably to the control apparatus 3.

The number of arms of the robot arm 200 is one to five, seven, or more. Further, the robot 2 may be a scalar robot or a dual-arm robot including two or more of the robot arms 200.

### 1.1.2. Force Sensor

The robot 2 further includes a force sensor 59 provided between the robot arm 200 and the end effector 5. The force sensor 59 includes a six-axis force sensor and a three-axis force sensor. The force sensor 59 is provided, and thereby, directions and magnitude of the forces applied to the end effector 5 and the robot arm 200 may be accurately detected. The force sensor 59 is communicably coupled to the control apparatus 3. Note that the position in which the force sensor 59 is provided is not limited to that, but may be provided between the respective arms 201 to 206.

### 1.1.3. End Effector

As described above, the end effector 5 includes the tool coupling unit 51, the tool 52, and the tool drive unit 53.

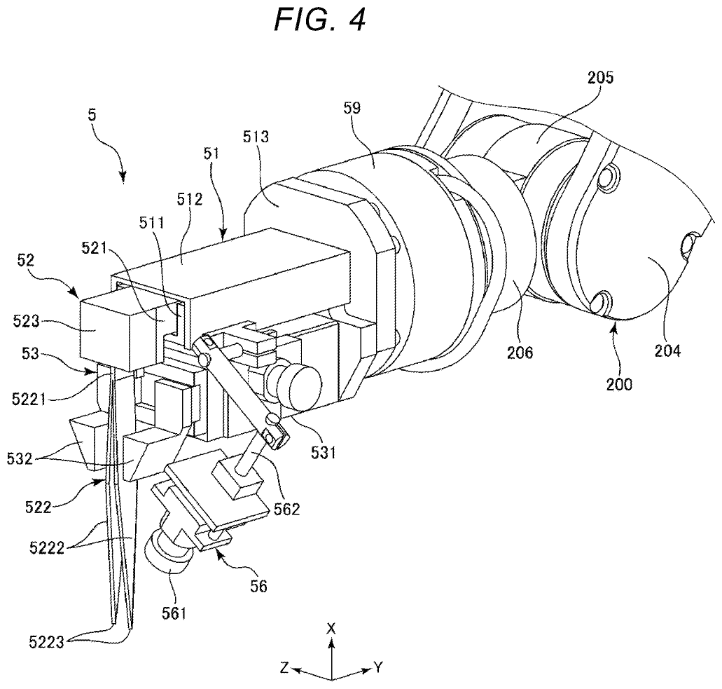

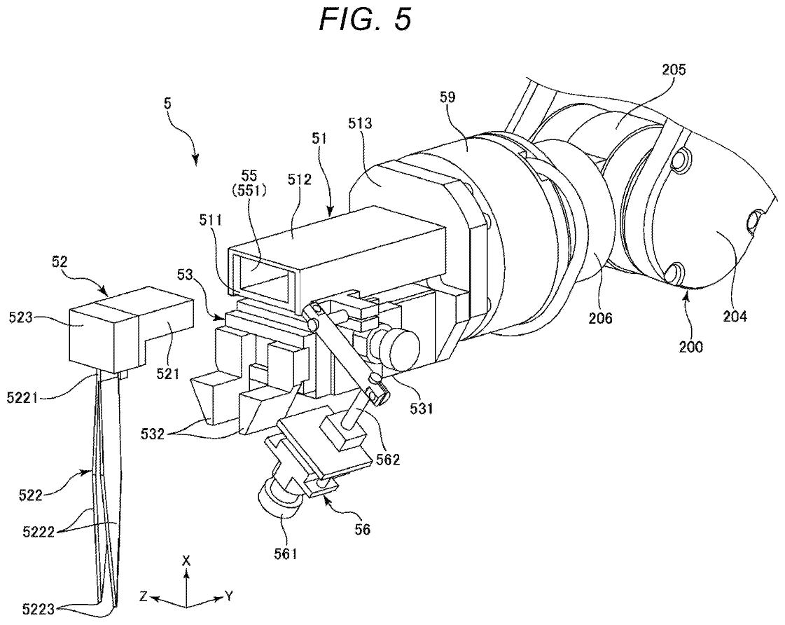

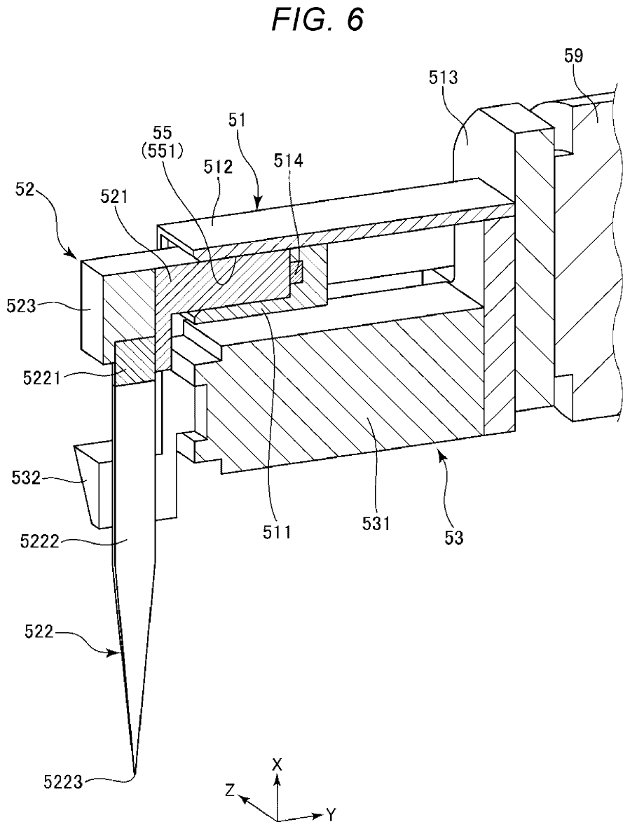

FIG. 4 is the partially enlarged perspective view showing the vicinity of the end effector 5 shown in FIG. 1. FIG. 5 is the perspective view showing the state in which fitting of the fitted portion and the fitting portion is released in the end effector 5 shown in FIG. 4. FIG. 6 is the sectional view of FIG. 4.

### 1.1.3.1. Tool Coupling Unit

The tool coupling unit 51 includes a coupling lower portion 511, a coupling upper portion 512, a supporting plate 513, and a magnet 514.

The coupling lower portion 511 is a member extending along the Y-axis and combined with the coupling upper portion 512 to form a fitting portion insertion space 55 in which a fitting portion 521 of the tool 52, which will be described later, can be inserted. The fitting portion insertion space 55 functions as a fitted portion 551 fitted with the fitting portion 521 of the tool 52 to be described later. The fitting refers to fitting of the fitting portion 521 and the fitted portion 551. Under the condition, the fitting portion 521 may be fixed to the fitted portion 551 with higher position accuracy. For keeping fixation, no drive energy of electricity, compressed air, or the like is required. Accordingly, no mechanism for converting the drive energy into mechanical drive power is required. Therefore, the weight and size of the end effector 5 may be reduced.

The fitting portion insertion space 55 is a space in a quadrangular prism shape extending along the Y-axis. The end surface at the Y-axis minus side opens and the end surface at the Y-axis plus side, the side surface at the Z-axis plus side, the side surface at the Z-axis minus side, the upper surface at the X-axis plus side, and the lower surface at the X-axis minus side are respectively closed. Thus, when the tool 52 moves from the Y-axis minus side toward the Y-axis plus side, in other words, when the fitting portion insertion space 55 is moved from the Y-axis plus side toward the Y-axis minus side, the fitting portion 521 of the tool 52 may be fitted into the fitting portion insertion space 55 (fitted portion 551).

Note that the section shape of the fitting portion insertion space 55 along the X-Z plane is not limited to the above described rectangular shape, but may be another polygonal shape than the rectangular shape, elliptical shape, oval shape, or the like.

The coupling lower portion 511 forms the lower surface, both side surfaces, and the end surface of the fitting portion insertion space 55. Further, the coupling upper portion 512 is a member extending along the Y-axis. The coupling upper portion 512 forms the upper surface of the fitting portion insertion space 55.

The end part at the Y-axis plus side of the fitting portion 521 is coupled to the distal end of the robot arm 200 via the supporting plate 513. Thereby, the tool coupling unit 51 is fixed to the robot arm 200.

The magnet 514 is provided on the end surface at the Y-axis plus side of the fitting portion insertion space 55. When the fitting portion 521 is inserted into the fitting portion insertion space 55, the magnet 514 attracts the fitting portion 521 by a magnetic force. Then, the magnet 514 and the fitting portion 521 adhere to each other, and thereby, the fitted portion 551 and the fitting portion 521 may be positioned and fixed to each other. Thereby, the position accuracy of the tool 52 relative to the robot arm 200 may be easily increased.

Note that the magnet 514 may be provided in another position than that described above of the tool coupling unit 51. Further, the magnet 514 may be provided on the tool 52 or provided on both the tool coupling unit 51 and the tool 52.

### 1.1.3.2. Tool

The tool 52 according to the embodiment has a tool main body 522 in a tweezers shape. Specifically, the tool 52 shown in FIG. 5 has the elongated tool main body 522 extending along the X-axis, a supporting portion 523 that supports the end portion at the X-axis plus side of the tool main body 522, and the above described fitting portion 521 projecting from the supporting portion 523 toward the Y-axis plus side.

The tool main body 522 includes a support portion 5221 supported by the supporting portion 523 and two finger portions 5222, 5222 extending from the support portion 5221 toward the X-axis minus side. An object is nipped between the two finger portions 5222, 5222, and thereby, the object may be gripped. Further, distal ends 5223 of the finger portions 5222 provide translational forces to the object, and thereby, may perform e.g. work of pushing and work of pulling the object along the Z-axis and work of pushing and work of pulling the object along the Y-axis.

The tool main body 522 has a spring property and a shape in which the distal ends 5223, 5223 are apart from each other under natural condition, i.e., without application of an external force. Accordingly, when a force is applied in the directions in which the finger portions 5222, 5222 are moved closer, the distal ends 5223, 5223 contact. Then, the applied force is released, the distal ends 5223, 5223 naturally separate. Therefore, gripping and release of the object may be efficiently performed using the spring property of the tool main body 522.

The supporting portion 523 is located outside of the fitting portion insertion space 55 as the fitted portion 551. Accordingly, the tool main body 522 is also located outside of the fitting portion insertion space 55 and extends from the supporting portion 523 toward the X-axis minus side. Thereby, the larger space may be secured around the distal ends of the finger portions 5222, 5222 and workability is higher. Further, the lengths of the finger portions 5222, 5222 are increased, and thereby, for example, when the supporting portion 523 is pivoted about the Y-axis even at the smaller pivot angles, the amounts of displacement of the distal ends of the finger portions 5222, 5222 may be secured to be larger.

As described above, the fitting portion 521 has the quadrangular prism shape extending along the Y-axis for fitting in the fitting portion insertion space 55 as the fitted portion 551. The outer surface of the fitting portion 521 adjoins the inner surface of the fitted portion 551 in a sufficiently large area via a slight gap. Thereby, moment load acts on the fitting portion 521. For example, when the work of pushing or work of pulling the object along the Z-axis or the work of pushing or work of pulling the object along the Y-axis is performed with the distal ends of the finger portions 5222, 5222 or the like, the bending moment or torsion moment is generated in the respective parts of the fitting portion 521. Then, larger loads are respectively applied to the fitting portion 521 and the fitted portion 551. However, the fitting portion 521 and the fitted portion 551 are fitted and, local stress concentration may be suppressed even when the larger loads are applied thereto. Thereby, breakage, deterioration, or the like of the fitting portion 521 and the fitted portion 551 may be suppressed.

Note that, in FIG. 5, the section shape of the fitting portion 521 along the X-Z plane is set according to the section shape of the fitting portion insertion space 55, however, the section shape is not limited to the above described rectangular shape, but may be another polygonal shape than the rectangular shape, elliptical shape, oval shape, or the like.

### 1.1.3.3. Tool Drive Unit

The tool drive unit 53 is provided at the X-axis minus side of the tool coupling unit 51. The end portion at the Y-axis plus side of the tool drive unit 53 is coupled to the distal end of the robot arm 200 via the supporting plate 513. Thereby, the tool drive unit 53 is fixed to the robot arm 200.

Specifically, the tool drive unit 53 has a power section 531 that generates the drive power and two transmission portions 532, 532 that transmit the drive power to the tool main body 522.

The power section 531 generates the drive power for opening and closing the two transmission portions 532, 532 along the Z-axis. Thereby, the distance between the transmission portions 532, 532 may be changed. In the power section 531, the drive power is generated using drive energy of electricity, compressed air, or the like.

The tool main body 522 is placed between the transmission portions 532, 532. For example, when the distance between the transmission portions 532, 532 is reduced, the finger portions 5222, 5222 of the tool main body 522 also move closer to each other. Thereby, the tool main body 522 may grip the object. On the other hand, when the distance between the transmission portions 532, 532 is made larger, the distal ends 5223, 5223 also move away from each other because of the spring property of the tool main body 522. Thereby, the gripping of the object by the tool main body 522 may be released.

Note that the configuration of the tool drive unit 53 is not limited to the above described configuration. For example, the transmission portion 532 may be placed between the finger portions 5222, 5222. In this case, it is preferable that the tool main body 522 forms e.g. a shape in which the distal ends 5223, 5223 are in contact with each other under natural condition.

### 1.1.3.4. Other Devices Etc.

The robot system 1 may include other arbitrary members, devices, etc. The arbitrary devices include e.g. an imaging unit 56 that images the working object, the robot 2, or around, a pressure-sensitive sensor that detects the external force applied to the robot 2, and a proximity sensor that detects an object approaching around the robot 2 or the like.

The above described imaging unit 56 is attached to the end effector 5 shown in FIG. 5. The imaging unit 56 shown in FIG. 5 includes a camera 561 and a coupler 562 coupling the camera 561 and the end effector 5. The camera 561 images e.g. the vicinity of the distal ends 5223 of the finger portions 5222 and detects the object and the gripping condition thereof or the like.

### 1.2. Control Apparatus

The control apparatus 3 shown in FIG. 2 has a control unit 31, a memory unit 32, an external input/output unit 33. The control apparatus 3 has a function of controlling driving of the robot arm 200 by outputting drive signals to the drive units 230 based on the detection results of the position sensors 240. Further, a display device 311 including e.g. a liquid crystal monitor and an input device 312 including e.g. a keyboard are coupled to the control apparatus 3.

The control unit 31 executes various programs etc. stored in the memory unit 32. Thereby, the control unit 31 may perform control of driving of the robot 2, various calculations, various determinations, etc. Specifically, the control unit 31 has a function of controlling the actuation of the robot arm 200 based on the output of the force sensor 59. Thereby, the control unit 31 performs first control to detach the tool 52 from the robot arm 200 by releasing the fitting of the fitted portion 551 and the fitting portion 521 and second control to attach the tool 52 to the robot arm 200 by fitting the fitted portion 551 to the fitting portion 521.

In the memory unit 32, various programs that can be executed by the control unit 31 are stored. Further, in the memory unit 32, various kinds of data received by the external input/output unit 33 is stored.

The external input/output unit 33 is used for connection to arbitrary devices provided outside in addition to the connection to the control apparatus 3, the robot 2, the display device 311, and the input device 312.

The hardware configuration of the control apparatus 3 is not particularly limited, but includes e.g. a controller 610 communicably coupled to the robot 2 and a computer 620 communicably coupled to the controller 610 as shown in FIG. 3.

The processors shown in FIG. 3 include e.g. CPUs (Central Processing Units), FPGAs (Field-Programmable Gate Arrays), and ASIC (Application Specific Integrated Circuits).

The memories shown in FIG. 3 include e.g. volatile memories such as RAMs (Random Access Memories) and nonvolatile memories such as ROMs (Read Only Memories). Note that the memories are not limited to the undetachable types, but may have detachable external memory devices.

The external interfaces shown in FIG. 3 include e.g. various communication technologies. The communication technologies include e.g. USB (Universal Serial Bus), RS-232C, wired LAN (Local Area Network), and wireless LAN.

Note that the hardware configuration of the control apparatus 3 is not limited to the configuration shown in FIG. 3. Further, another configuration may be added to the control apparatus 3 in addition to the above described configuration. Furthermore, various programs, data, etc. stored in the memory unit 32 may be stored in the memory unit 32 in advance, or stored in a recording medium e.g. a CD-ROM or the like and provided from the recording medium or provided via a network or the like.

### 1.3. Platform

The platform 4 shown in FIG. 1 has a frame body 41, leg parts 42 extending downward from the lower part of the frame body 41, a top board 43 and a spacer 45 fixed to the upper part of the frame body 41, and a shelf board 44 fixed inside of the frame body 41. The platform 4 is placed on a floor, a table on the floor, a carriage movable on the floor, or the like. The platform 4 may be provided as necessary, but may be omitted. When the platform 4 is omitted, the robot 2 may be fixed directly to the floor, a wall, a ceiling, or the like or indirectly via an arbitrary member.

The frame body 41 shown in FIG. 1 is a structure having bar-shaped base materials extending along edge lines of a rectangular parallelepiped and coupled to one another. The leg parts 42 are members projecting downward from the lower surface of the frame body 41.

The top board 43 and the spacer 45 are provided on the upper surface of the frame body 41. Further, the robot 2 is placed on the top board 43 via the spacer 45.

On the shelf board 44, the control apparatus 3 is placed. The control apparatus 3 shown in FIG. 1 may be simply placed on the shelf board 44, or fixed to the shelf board 44 using a fixing member (not shown). Note that, on the shelf board 44, an arbitrary device e.g. a vacuum pump, uninterruptible power supply, or the like may be placed in addition to the control apparatus 3.

### 1.4. Tool Stocker

The tool stocker 7 shown in FIG. 1 has a stocker plate 71 and holders 721, 722, 723 and has a function of stocking the tools 52.

The stocker plate 71 is a plate body spreading along the Y-Z plane. The stocker plate 71 is supported on a floor or the like by led parts (not shown) and held at a predetermined height.

The holders 721, 722, 723 respectively have functions of holding the tools 52 and are sequentially arranged from the Z-axis plus side toward the Z-axis minus side. As an example, the other tools 52 than the tool 52 attached to the robot arm 200 are respectively held by the holders 721 and 723.

Each of the holders 721, 722, 723 has a power section 724 that generates drive power and two holding fingers 725, 725 that hold the tool 52 by the drive power. The power section 724 generates the drive power for opening and closing the two holding fingers 725, 725 along the Z-axis. Thereby, the distance between the holding fingers 725 may be changed. In the power section 724, the drive power is generated using drive energy of electricity, compressed air, or the like. Further, the power section 724 is communicable with the control apparatus 3. When the distance between the holding fingers 725 is reduced, the supporting portion 523 of the tool 52 may be held. On the other hand, when the distance between the holding fingers 725 is made larger, the holding of the tool 52 may be released.

### 1.5. Control Method for Robot System

Next, the tool replacement method according to the embodiment as the control method for the robot system 1 will be explained.

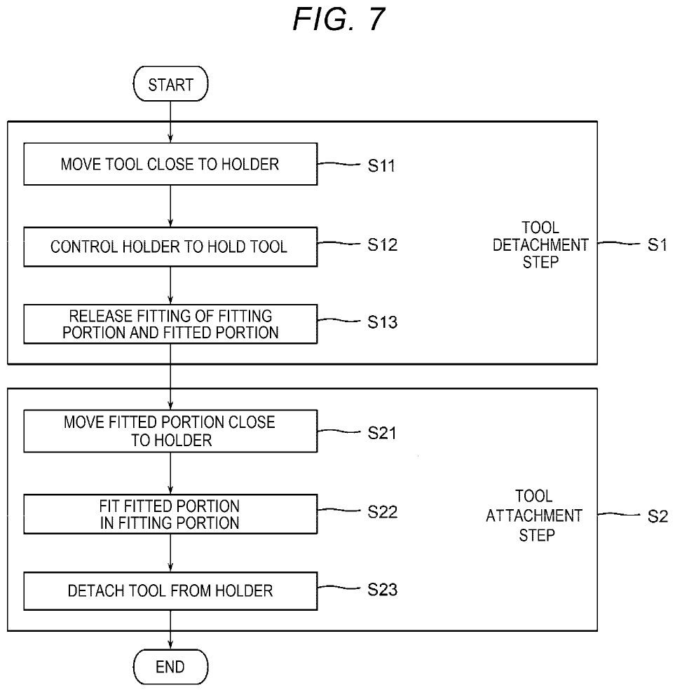

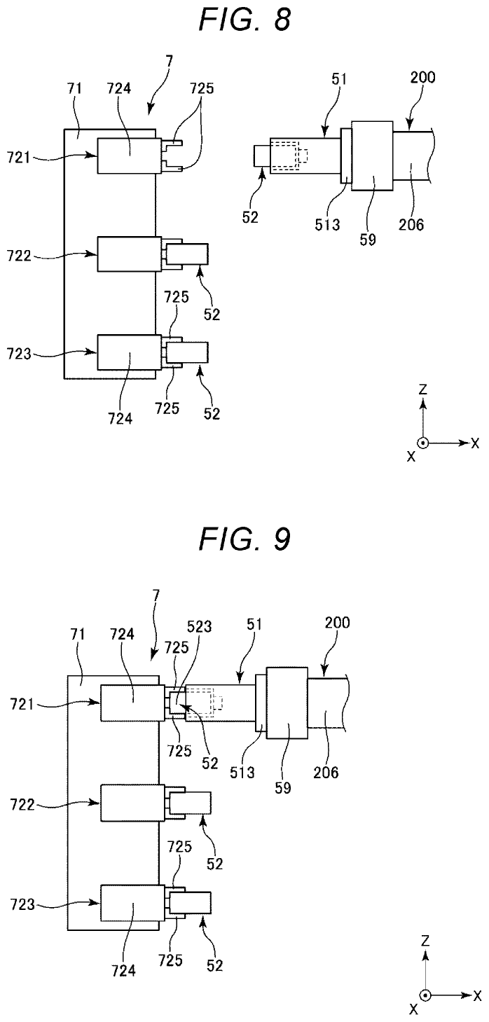

FIG. 7 is the process chart showing the tool replacement method according to the embodiment. FIGS. 8 to 13 are respectively the diagrams for explanation of the tool replacement method shown in FIG. 7.

The tool replacement method shown in FIG. 7 has a tool detachment step S1 of detaching the tool 52 from the robot arm 200 based on the output of the force sensor 59 by the control apparatus 3 and a tool attachment step S2 of attaching the tool 52 to the robot arm 200 based on the output of the force sensor 59 by the control apparatus 3. As below, the respective steps will be sequentially explained.

### 1.5.1. Tool Detachment Step S1

At this step, the tool 52 attached to the robot arm 200 is detached from the robot arm 200 and passed to the holder 721. The step has the following step S11, step S12, and step S13.

First, as step S11, the robot arm 200 is driven by the control apparatus 3 and, as shown in FIG. 8, the tool 52 is moved to the vicinity of the holder 721. The movement may be performed by actuation of the drive units 230 based on the output of the above described position sensors 240.

Then, as step S12, the supporting portion 523 of the tool 52 is held by the holder 721. As described above, the holder 721 has the power section 724 and the holding fingers 725, 725 and can hold the supporting portion 523 of the tool 52 between the holding fingers 725. To control the holder 721 to hold the supporting portion 523, first, the holding fingers 725 are moved away from each other by the power section 724 and a space for nipping the supporting portion 523 is secured. Then, the robot arm 200 is driven by the control apparatus 3 and, as shown in FIG. 9, the supporting portion 523 is inserted between the holding fingers 725. Here, control called “profile control” is performed.

The profile control refers to control to monitor the output of the force sensor 59 by the control apparatus 3 and drive the robot arm 200 so that the external force applied to the supporting portion 523 by the holder 721 may be smaller. Specifically, when the supporting portion 523 is inserted between the holding fingers 725, the external force applied to the supporting portion 523 due to contact of the supporting portion 523 with the holding fingers 725 is detected by the force sensor 59.

The external force includes both the translational force and the rotational force with respect to each axis. Further, the robot arm 200 is driven to move the supporting portion 523 in the direction in which the external force is zero. By the above described control, the movement trajectory of the supporting portion 523 becomes a trajectory in which the supporting portion 523 passes through nearly the middle of the holding fingers 725 with repeated wobbling. Thereby, strong interferences between the supporting portion 523 and the holding fingers 725 may be prevented. As a result, damage on either or both of the supporting portion 523 and the holding fingers 725 or holding of either or both in unintended postures may be prevented.

The above described profile control is performed, and thereby, the supporting portion 523 may be inserted between the holding fingers 725 without effort. When the supporting portion 523 abuts against the deepest portion at the Y-axis minus side and the insertion of the supporting portion 523 is completed, that is detected by a sensor (not shown) provided between the holding fingers 725. When receiving the detection signal, the control apparatus 3 outputs a control signal to the power section 724 of the holder 721. Thereby, the holding fingers 725 of the holder 721 are moved closer to each other to hold the supporting portion 523 of the tool 52. As a result, the tool 52 is held by the holder 721 and attached to the robot arm 200. Note that, in place of the above described sensor detecting the completion of insertion, the completion of insertion may be detected based on the output by the position sensors 240, detected based on the output of the force sensor 59, or detected based on the output of the camera 561 or another sensor.

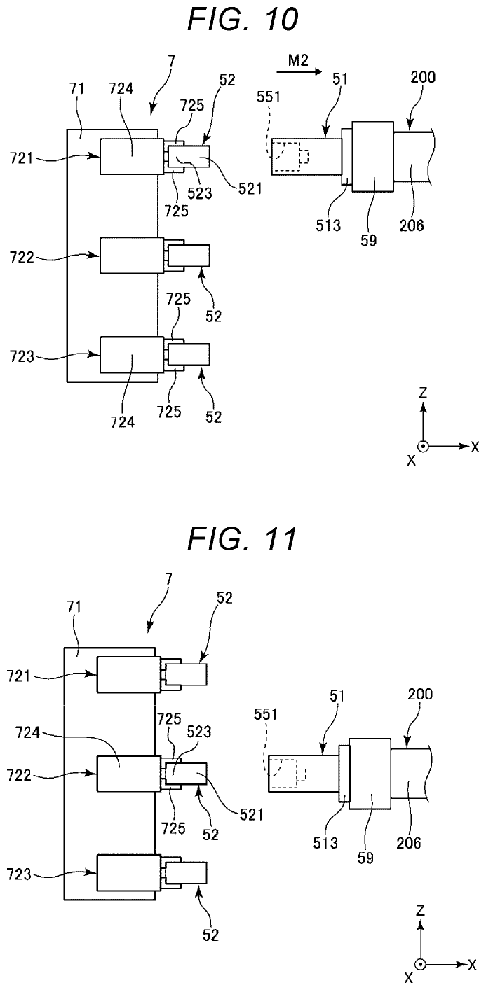

Then, as step S13, the robot arm 200 is driven by the control apparatus 3 and the tool 52 is detached from the robot arm 200. To detach the tool 52 from the robot arm 200, it is necessary to drive the robot arm 200 to pull the fitting portion 521 from the fitted portion 551, that is, as shown by an arrow M2 in FIG. 10. Also, in this case, the above described “profile control” is performed.

Specifically, when the fitting portion 521 is pulled from the fitted portion 551, the external force applied to the fitted portion 551 due to contact of the fitted portion 551 with the fitting portion 521 is detected by the force sensor 59. Then, the robot arm 200 is driven to move the fitted portion 551 in the direction in which the external force is zero. By the above described control, strong interferences between the fitting portion 521 and the fitted portion 551 may be prevented and damage on either or both or an unintended posture of the fitting portion 521 hard to be pulled out may be prevented.

By the first control including the above described two profile controls, as shown in FIG. 10, the tool 52 attached to the robot arm 200 may be passed to the holder 721. Note that the above described profile control is an example of the control method, but another control method may be employed.

### 1.5.2. Tool Attachment Step

At this step, the tool 52 held by the holder 722 is detached from the holder 722 and attached to the robot arm 200. The step has the following step S21, step S22, and step S23.

First, as step S21, the robot arm 200 is driven by the control apparatus 3 and, as shown in FIG. 11, the fitted portion 551 is moved to the vicinity of the holder 722. The movement may be performed by actuation of the drive units 230 based on the output of the above described position sensors 240.

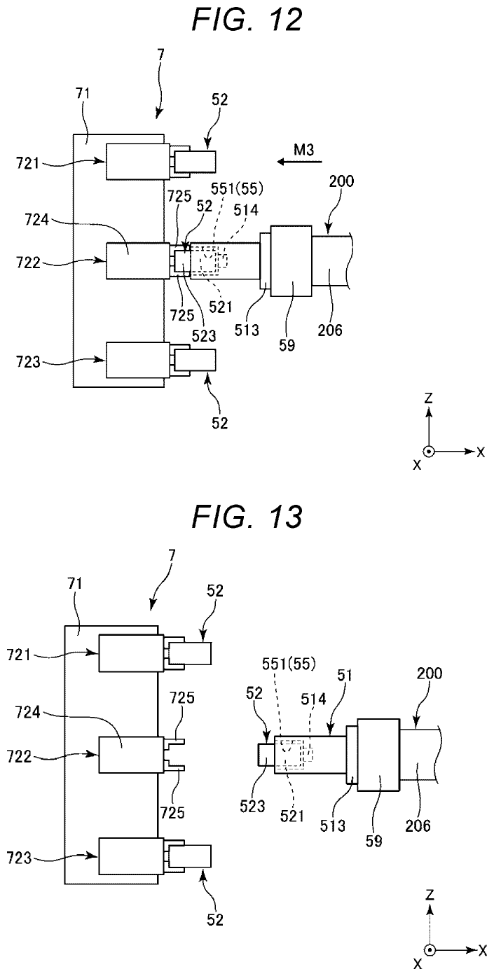

Then, as step S22, the fitted portion 551 of the tool coupling unit 51 is fitted in the fitting portion 521 of the tool 52. Specifically, the robot arm 200 is driven as shown by an arrow M3 in FIG. 12 by the control apparatus 3 to insert the fitting portion 521 into the fitted portion 551. Here, control called “exploring control”, which will be described later, and “profile control” are performed.

The exploring control refers to control to monitor the output of the force sensor 59 by the control apparatus 3 and drive the robot arm 200 to explore the opportunity of the insertion of the fitted portion 551 into the fitting portion 521 according to the external force applied to the fitted portion 551 by the fitting portion 521. Specifically, when the fitting portion 521 is inserted into the fitting portion insertion space 55 as the fitted portion 551, the external force applied to the fitted portion 551 due to the contact of the fitted portion 551 with the fitting portion 521 is detected by the force sensor 59. Note that a specific example of the exploring control will be described later in detail.

Subsequently, the fitting portion 521 is fitted in the fitted portion 551 by the above described profile control. As described above, the profile control refers to control to monitor the output of the force sensor 59 by the control apparatus 3 and drive the robot arm 200 so that the external force applied to the fitted portion 551 by the fitting portion 521 may be smaller. Specifically, when the fitting portion 521 is fitted in the fitted portion 551, the external force applied to the fitted portion 551 due to the contact of the fitted portion 551 with the fitting portion 521 is detected by the force sensor 59.

The external force includes both the translational force and the rotational force with respect to each axis. Further, the robot arm 200 is driven to move the fitted portion 551 in the direction in which the external force is zero. By the above described control, the movement trajectory of the fitted portion 551 becomes a trajectory nearly overlapping with the center line of the fitting portion 521 with repeated wobbling. Thereby, strong interferences between the fitting portion 521 and the fitted portion 551 may be prevented. As a result, damage on either or both of the fitting portion 521 and the fitted portion 551 or immovability of either or both in unintended postures may be prevented.

The above described profile control is performed, and thereby, the fitting portion 521 may be fitted in the fitted portion 551 without effort. When the fitting is completed, the magnet 514 attracts the fitting portion 521. Further, the control apparatus 3 detects the completion of fitting based on e.g. the output of the force sensor 59. As a result, the tool 52 is attached to the robot arm 200 and held by the holder 722. Note that the completion of fitting may be detected using the output by the position sensors 240 in place of the output of the force sensor 59, detected using both, or detected using the output of the camera 561 or another sensor.

Then, as step S23, the robot arm 200 is driven by the control apparatus 3 and the tool 52 attached to the robot arm 200 is detached from the holder 722. To detach the tool 52 from the holder 722, first, a control signal is output to the power section 724 of the holder 722 by the control apparatus 3. Thereby, as shown in FIG. 13, the distance between the holding fingers 725 of the holder 722 is increased and holding of the tool 52 is released.

By the second control including the above described exploring control and profile control, the tool 52 held by the holder 722 may be attached to the robot arm 200. Note that the above described exploring control and profile control are respectively examples of the control method, but another control method may be employed.

Here, the above described exploring control is explained.

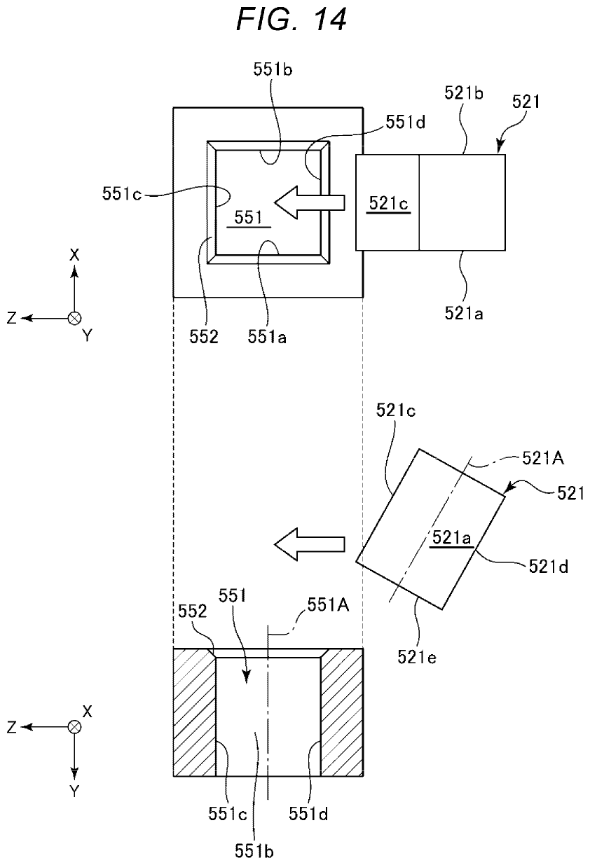

FIGS. 14 to 18 are diagrams for explanation of the examples of the exploring control in two views from different angles arranged one above the other. Note that, in FIGS. 14 to 18, the fitted portion 551 and the fitting portion 521 are schematically shown.

The inner surfaces of the fitted portion 551 shown in FIG. 14 include a lower surface 551a located in the lower part, an upper surface 551b located in the upper part, a side surface 551c located at the Z-axis plus side, and a side surface 551d located at the Z-axis minus side.

The outer surfaces of the fitting portion 521 shown in FIG. 14 include a lower surface 521a located in the lower part at fitting, an upper surface 521b located in the upper part at fitting, a side surface 521c located at the Z-axis plus side at fitting, a side surface 521d located at the Z-axis minus side at fitting, and an end surface 521e.

In the exploring control, first, as shown in FIG. 14, the fitting portion 521 is relatively moved to a position in which a part of the fitting portion 521 is inserted into the fitted portion 551 in a state in which an axial line 521A of the fitting portion 521 is inclined relative to an axial line 551A of the fitted portion 551 (inclined state). Specifically, the fitting portion 521 is inclined so that the end surface 521e of the fitting portion 521 may face the side surface 551c of the fitted portion 551. Note that it is only necessary to relatively move the fitting portion 521. In the case of the embodiment, the fitting portion 521 is not moved, but the fitted portion 551 is moved to relatively move the fitting portion 521. The same applies to the following description.

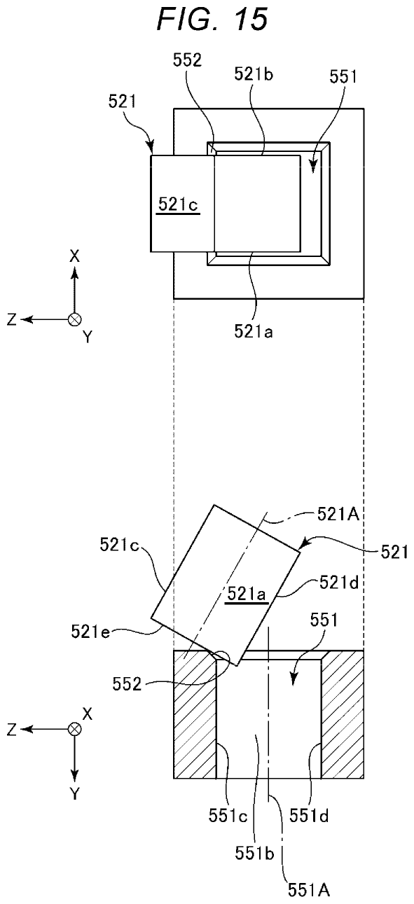

Then, as shown in FIG. 15, the fitting portion 521 is moved toward the Z-axis plus side until the end surface 521e of the fitting portion 521 contacts the side surface 551c of the fitted portion 551. Note that, as shown in FIG. 15, when a tapered portion 552 is formed in the side surface 551c, the fitting portion 521 is moved toward the Z-axis plus side until the end surface 521e of the fitting portion 521 contacts the tapered portion 552.

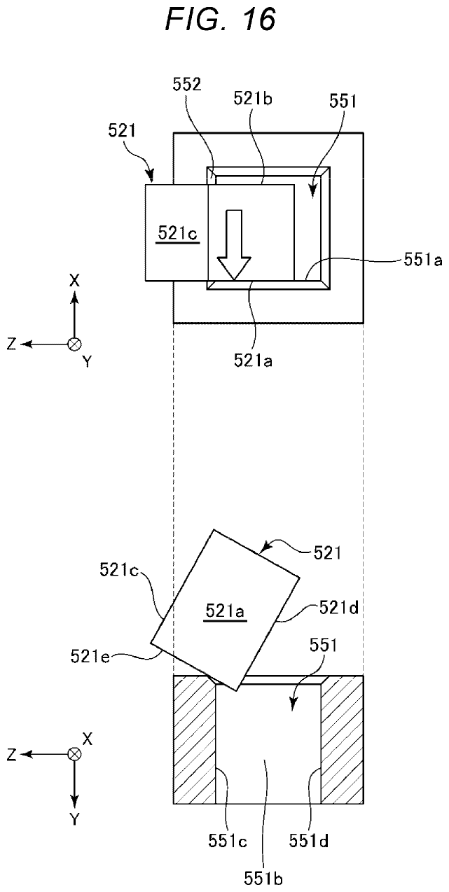

Then, as shown in FIG. 16, the fitting portion 521 is moved toward the X-axis minus side until the lower surface 521a of the fitting portion 521 contacts the lower surface 551a of the fitted portion 551.

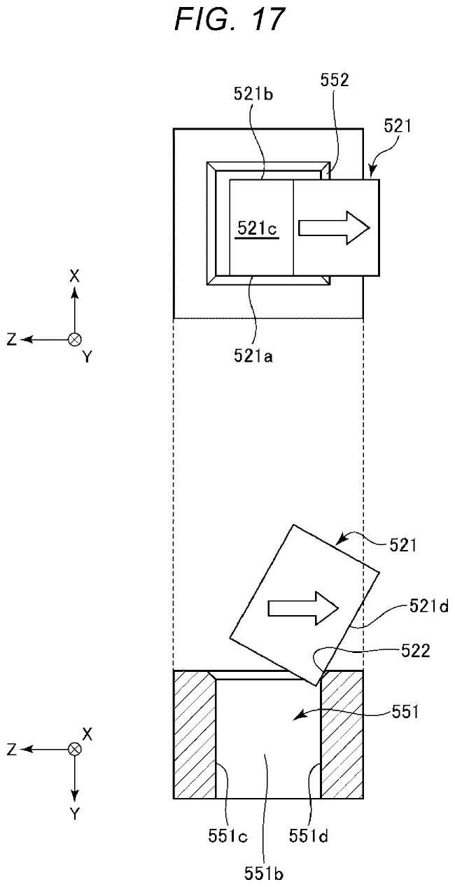

Then, as shown in FIG. 17, the fitting portion 521 is moved toward the Z-axis minus side until the side surface 521d of the fitting portion 521 contacts the side surface 551d of the fitted portion 551. Note that, as shown in FIG. 15, when a tapered portion 552 is formed in the side surface 551d, the fitting portion 521 is moved toward the Z-axis minus side until the side surface 521d of the fitting portion 521 contacts the tapered portion 552. Then, the position relationship between the fitting portion 521 and the fitted portion 551 is a position relationship in which the fitting portion 521 can be inserted into the fitted portion 551 when the above described inclined state is dissolved.

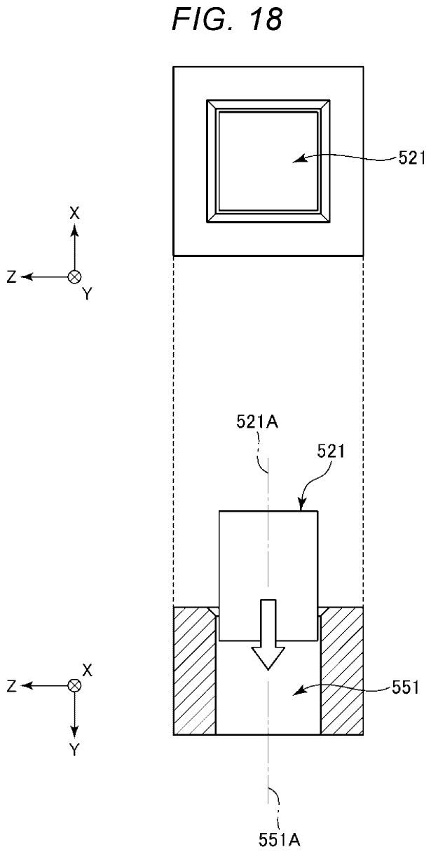

Then, as shown in FIG. 18, the inclined state is dissolved. Specifically, the state in which the axial line 551A of the fitted portion 551 is inclined relative to the axial line 521A of the fitting portion 521 is shifted to a state in which the axial line 521A and the axial line 551A are parallel. Thereby, the fitting portion 521 can be inserted into the fitted portion 551.

As described above, the tool replacement method according to the embodiment is a method in the robot system 1 having the robot 2 including the robot arm 200, the force sensor 59 provided in the robot arm 200, the fitted portion 551 provided at the opposite side to the robot arm 200 via the force sensor 59, the tool 52 having the fitting portion 521 fitted in the fitted portion 551, and the control apparatus 3 that controls actuation of the robot 2. The tool replacement method has the tool detachment step S1 and the tool attachment step S2. The tool detachment step S1 is the step of detaching the tool 52 from the robot arm 200 by driving the robot arm 200 based on the output of the force sensor 59 and releasing the fitting of the fitted portion 551 and the fitting portion 521 by the control apparatus 3. The tool attachment step S2 is the step of attaching the tool 52 to the robot arm 200 by driving the robot arm 200 based on the output of the force sensor 59 and fitting the fitted portion 551 in the fitting portion 521 by the control apparatus 3.

According to the tool replacement method, the replacement of the tool 52 can be performed by the actuation of the control apparatus 3, and thus, the robot system 1 may replace the tool 52 without human work. Thereby, labor-saving may be easily realized in various works performed by the robot system 1. Further, a mechanism such as a chuck mechanism or tool changer used for replacement of the tool 52 in related art is unnecessary by using the fitting of the fitting portion 521 and the fitted portion 551. Accordingly, the size and weight of the end effector 5 may be easily reduced and the substantially large weight capacity may be secured by the small robot arm 200.

The robot system 1 according to the embodiment has the robot 2 including the robot arm 200, the force sensor 59 provided in the robot arm 200, the fitted portion 551 provided at the opposite side to the robot arm 200 via the force sensor 59, the tool 52 having the fitting portion 521 fitted in the fitted portion 551, and the control apparatus 3 that controls actuation of the robot 2. The control apparatus 3 performs the first control and the second control. The first control is the control to detach the tool 52 from the robot arm 200 by driving the robot arm 200 based on the output of the force sensor 59 and releasing the fitting of the fitted portion 551 and the fitting portion 521. The second control is the control to attach the tool 52 to the robot arm 200 by driving the robot arm 200 based on the output of the force sensor 59 and fitting the fitted portion 551 in the fitting portion 521.

According to the robot system 1, the replacement of the tool 52 can be performed by the actuation of the control apparatus 3, and thus, the tool 52 may be replaced without human work. Thereby, labor-saving may be easily realized in various works performed by the robot system 1. Further, a mechanism such as a chuck mechanism or tool changer used for replacement of the tool 52 in related art is unnecessary using the fitting of the fitting portion 521 and the fitted portion 551. Accordingly, the size and weight of the end effector 5 may be easily reduced and the substantially large weight capacity may be secured by the small robot arm 200.

As described above, the fitting portion 521 has the columnar shape having an axis parallel to the axial line 521A, and the section shape of the fitting portion 521 cut along a plane having a normal parallel to the axis is preferably a polygonal shape or elliptical shape of the above described shapes. In other words, the axis along the direction in which the fitting portion 521 is fitted in the fitted portion 551 is the axis parallel to the axial line 521A, and the section shape of the fitting portion 521 cut along a plane having a normal parallel to the axis is preferably a polygonal shape or elliptical shape. According to the shape, for example, when a load that pivots the fitting portion 521 is applied to the fitted portion 551 about the axis, idle rotation may be prevented. Further, the shape has an advantage that fitting work is easily performed.

The robot 2 includes the magnet 514 as an attraction mechanism provided on the fitted portion 551 and attracted to the fitting portion 521. The attraction mechanism is provided, and thereby, the fitted portion 551 and the fitting portion 521 may be positioned and fixed to each other. Thereby, the position accuracy of the tool 52 relative to the robot arm 200 may be easily increased.

Note that, in place of the attraction mechanism, an engagement mechanism that engages the fitting portion 521 may be provided. That is, the robot 2 preferably includes the attraction mechanism or the engagement mechanism. The engagement mechanism includes e.g. a plunger. The plunger is formed by a combination of an engaging portion and an engaged portion and may perform positioning or the like. The plunger includes e.g. a ball plunger, pin plunger, index plunger, stroke plunger, spring plunger, press-fit plunger, and short plunger.

Note that the engagement mechanism may be provided in the tool coupling unit 51 or tool 52.

The fitted portion 551 shown in FIGS. 14 to 18 has the tapered portion 552 having a tapered shape that guides and fits the fitting portion 521. The tapered portion 552 has a tapered shape tapered in the direction in which the inside dimension of the fitting portion insertion space 55 as the fitted portion 551 is increased. The tapered portion 552 is provided, and thereby, when the fitted portion 551 is fitted in the fitting portion 521, if the relative positions are slightly shifted, the position of the fitting portion 521 may be guided in a direction toward the axial line 551A of the fitted portion 551 as long as the fitting portion 521 may be brought into contact with the tapered portion 552. Thereby, the position accuracy in fitting may be relaxed and the tool replacement method may be speeded up.

Note that the fitting portion 521 may include the tapered portion. Or, both the fitted portion 551 and the fitting portion 521 may include the tapered portions.

The robot system 1 according to the embodiment has the holder 721 that holds the tool 52. Further, the control apparatus 3 releases the fitting of the fitting portion 521 and the fitted portion 551 by driving the robot arm 200 based on the output of the force sensor 59 and controlling the holder 721 to hold the tool 52.

According to the configuration, after the tool 52 is once held by the holder 721, the fitting of the fitting portion 521 and the fitted portion 551 may be released only by driving of the robot arm 200 without using drive energy for releasing the fitting. Accordingly, for releasing the fitting, a mechanism such as a chuck mechanism or tool changer in related art is unnecessary, and the size and weight of the end effector 5 may be easily reduced.

### 2. Second Embodiment

Next, the robot system according to the second embodiment will be explained.

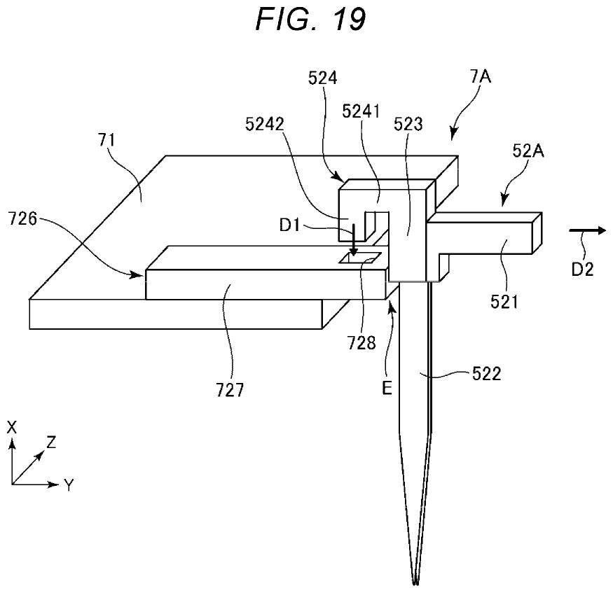

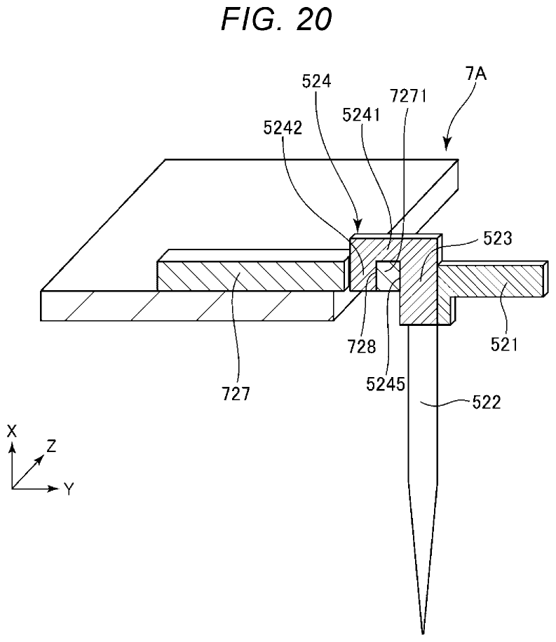

FIG. 19 is the perspective view showing the tool and the tool stocker provided in the robot system according to the second embodiment. FIG. 20 is the sectional view of the tool and the tool stocker shown in FIG. 19.

As below, the second embodiment will be explained, and the following explanation will be made with a focus on the differences from the first embodiment and the explanation of the same items will be omitted. Note that, in the respective drawings, the same configurations as those of the first embodiment have the same signs.

In the tool stocker 7 according to the above described first embodiment, the holders 721, 722, 723 respectively have the power sections 724 and the holding fingers 725, 725. On the other hand, in a tool stocker 7A according to the embodiment, a holder 726 has no power sections 724 or holding fingers 725, 725. As shown in FIGS. 19 and 20, the holder 726 has an engagement member 727 including an engagement hole 728. The engagement member 727 is a plate-like member placed on the stocker plate 71. The engagement hole 728 is a hole penetrating the engagement member 727 along the X-axis.

On the other hand, a tool 52A according to the embodiment has an engagement hook 524 provided in the supporting portion 523. The engagement hook 524 has a first portion 5241 extending from the supporting portion 523 toward the Y-axis minus side and a second portion 5242 extending from an end thereof toward the X-axis minus side.

The engagement hook 524 of the tool 52A is engaged with the engagement hole 728 of the holder 726, and thereby, the tool 52A may be held by the holder 726. Specifically, the second portion 5242 of the engagement hook 524 is inserted from above the engagement hole 728, and thereby, the engagement hole 728 and the engagement hook 524 engage. For the engagement, the above described exploring control and profile control may be used.

In the embodiment, the engagement hole 728 and the engagement hook 524 may engage, however, the engagement hook 524 may be engaged with the engagement hole 728 with sufficient margin and a part of the engagement member 727 may be fitted between the engagement hook 524 and the supporting portion 523. Specifically, as shown in FIG. 20, a gap 5245 between the engagement hook 524 and the supporting portion 523 and a part 7271 of the engagement member 727 may fit. Thereby, at the tool detachment step S1, when the engagement hook 524 is inserted into the engagement hole 728 by exploring control, positioning along the Y-axis may be easily performed by pressing of the supporting portion 523 against an end surface of the engagement member 727 shown by an arrow E in FIG. 19. Thereby, the exploring control may be efficiently performed. Further, the tool 52A may be reliably held by fitting.

On the other hand, at the tool attachment step S2, the robot arm 200 is driven to pull the engagement hook 524 from the engagement hole 728. For this, the exploring control is performed by the control apparatus 3.

In the above described second embodiment, the same effects as those of the first embodiment may be obtained.

Further, in the embodiment, the power sections 724 provided in the tool stocker 7 according to the first embodiment are unnecessary, and thus, power consumption may be reduced and the structure may be simplified in the robot system 1.

Furthermore, in the embodiment, the holder 726 includes the engagement hole 728 as the engagement portion for holding the tool 52A by engagement. The control apparatus 3 performs the first control so that a movement direction of the distal end of the robot arm 200 when the engagement hook 524 of the tool 52A is engaged with the engagement hole 728, i.e., a first movement direction D1 of the fitted portion 551 and a movement direction of the distal end of the robot arm 200 when the fitting of the fitting portion 521 and the fitted portion 551 is released, i.e., a second movement direction D2 of the fitted portion 551 may be non-parallel, that is, may not be parallel.

According to the control, the first movement direction D1 and the second movement direction D2 are non-parallel, and thus, for engagement of the engagement hook 524 with the engagement hole 728, when the distal end of the robot arm 200 is moved in the first movement direction D1, an influence by the movement on the fitting condition of the fitting portion 521 and the fitted portion 551 may be prevented. Similarly, for releasing the fitting of the fitting portion 521 and the fitted portion 551, when the distal end of the robot arm 200 is moved in the second movement direction D2, an influence by the movement on the engagement condition of the engagement hook 524 and the engagement hole 728 may be prevented.

Further, the first movement direction D1 and the second movement direction D2 are non-parallel, and thus, for example, when the fitting portion 521 is pulled from the fitted portion 551, it is not necessary to continue to hold the tool 52A using the drive energy. Accordingly, the control of the robot system 1 by the control apparatus 3 may be easier and the power consumption may be reduced.

Note that the above mentioned “non-parallel” refers to a state in which the first movement direction D1 and the second movement direction D2 are not parallel, and the angle formed by the first movement direction D1 and the second movement direction D2 is preferably from 30° to 90° and more preferably from 60° to 90°. In the example shown in FIGS. 19 and 20, the angle is 90°.

The configurations of the engagement hook 524 and the engagement hole 728 are not limited to the above described configurations. For example, the engagement hole 728 does not necessarily penetrate the engagement member 727. Further, the engagement includes the concept of fitting. Therefore, the engagement hook 524 may be fitted in the engagement hole 728.

### 3. Third Embodiment

Next, the robot system according to the third embodiment will be explained.

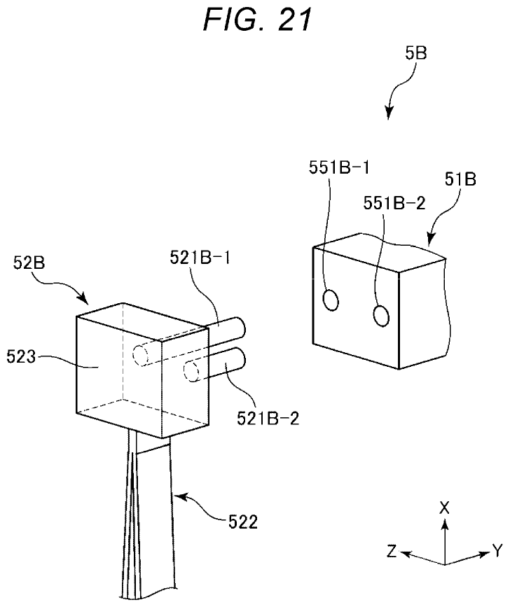

FIG. 21 is the partially enlarged perspective view showing the vicinity of the end effector provided in the robot system according to the third embodiment.

As below, the third embodiment will be explained, and the following explanation will be made with a focus on the differences from the first embodiment and the explanation of the same items will be omitted. Note that, in the respective drawings, the same configurations as those of the first embodiment have the same signs.

In the above described first embodiment, the tool 52 has the single fitting portion 521 in the quadrangular prism shape. On the other hand, in the embodiment, as shown in FIG. 21, a tool 52B has two fitting portions 521B-1, 521B-2 in cylindrical shapes. Further, in correspondence with the portions, a tool coupling unit 51B according to the embodiment has two fitted portions 551B-1, 551B-2.

As shown in FIG. 21, the fitting portions 521B-1, 521B-2 respectively have the cylindrical shapes extending along the Y-axis. Further, the fitting portions 521B-1, 521B-2 are arranged along the Z-axis. Furthermore, the length of the fitting portion 521B-1 along the Y-axis is longer than the length of the fitting portion 521B-2 along the Y-axis. That is, the fitting portions have the different lengths.

On the other hand, the fitted portions 551B-1, 551B-2 have spaces in the cylindrical shapes extending along the Y-axis. Further, the fitted portions 551B-1, 551B-2 are arranged along the Z-axis. Thereby, the above described fitting portions 521B-1, 521B-2 are inserted into the fitted portions 551B-1, 551B-2. Furthermore, the lengths of the fitted portions 551B-1, 551B-2 along the Y-axis are set to be equal to or more than lengths in which the entire lengths of the fitting portions 521B-1, 521B-2 can be inserted.

In an end effector 5B, the two fitting portions 521B-1, 521B-2 are arranged along the Z-axis, and thereby, for example, when a load that pivots the fitting portions 521B-1, 521B-2 relative to the fitted portions 551B-1, 551B-2 is applied about the Y-axis, idle rotation may be prevented.

Further, in the end effector 5B, at the tool detachment step S1, when the fitting portions 521B-1, 521B-2 are pulled from the fitted portions 551B-1, 551B-2, the movement of the fitted portions 551B-1, 551B-2 is controlled by profile control as is the case with the first embodiment.

At the tool attachment step S2, the fitting portions 521B-1, 521B-2 are fitted in the fitted portions 551B-1, 551B-2 by exploring control and profile control.

As described above, the length of the fitting portion 521B-1 along the Y-axis is longer than the length of the fitting portion 521B-2 along the Y-axis. Accordingly, when the robot arm 200 is driven and the tool coupling unit 51B is moved from the Y-axis plus side toward the tool 52B, first, the fitting portion 521B-1 reaches the opening of the fitted portion 551B-1. Here, if the fitting portion 521B-1 is in the position relationship in which the fitting portion can be inserted into the fitted portion 551B-1, the control may shift to the above described profile control.

On the other hand, when the fitting portion 521B-1 not inserted into the fitted portion 551B-1 is detected based on the output of the force sensor 59, exploring control is performed. In the exploring control, for example, the driving of the robot arm 200 is controlled so that the peripheral area of the fitted portion 551B-1 may be pressed against the fitting portion 521B-1 and the apparent movement trajectory of the fitting portion 521B-1 relative to the fitted portion 551B-1 may draw a spiral from outside to inside. Here, the diameter of the spiral is set so that the fitted portion 551B-1 may be located inside of the diameter of the spiral. Thereby, the distal end of the fitting portion 521B-1 is inserted into the fitted portion 551B-1 in any location of the movement trajectory.

Then, the fitting portion 521B-1 is inserted into the fitted portion 551B-1 by the above described profile control.

The insertion is continued, and then, the fitting portion 521B-2 reaches the opening of the fitted portion 551B-2. Here, if the fitting portion 521B-2 is in the position relationship in which the fitting portion can be inserted into the fitted portion 551B-2, the control may shift to the above described profile control.

On the other hand, when the fitting portion 521B-2 not inserted into the fitted portion 551B-2 is detected based on the output of the force sensor 59, exploring control is performed.

After the exploring control is completed, the fitting portion 521B-2 is inserted into the fitted portion 551B-2 by the above described profile control.

Through the above described respective steps, fitting of the fitting portions 521B-1, 521B-2 in the fitted portions 551B-1, 551B-2 is completed. Note that, using the fitting portions 521B-1, 521B-2 having the different lengths, exploring control may be sequentially performed on the fitting portion 521B-1 and the fitting portion 521B-2 in the above described manner. That is, performance of exploring control at the same time on the fitting portion 521B-1 and the fitting portion 521B-2 may be avoided. Thereby, even when the tool 52B has the two fitting portions 521B-1, 521B-2, the exploring control may be efficiently and reliably successful. In other words, when the exploring control is performed at the same time on the two fitting portion 521B-1, 521B-2, unsuccessful exploring control may be avoided.

In the above described third embodiment, the effects of the first embodiment may be obtained.

Note that the number of fitting portions 521B-1, 521B-2 is not limited to two, but may be three or more. In this case, it is preferable that the lengths of the respective fitting portions may be different from one another. Further, it is preferable that the number of the fitted portions is set to the same as the number of the fitting portions. Furthermore, the fitting portion 521B-1 and the fitting portion 521B-2 may have the same or different diameters. It is preferable that the fitting portion 521B-1 and the fitting portion 521B-2 have tapered portions as described above. Similarly, it is preferable that the fitted portion 551B-1 and the fitted portion 551B-2 have tapered portions.

As described above, in the robot system 1 according to the embodiment, the fitting portions 521B-1, 521B-2 respectively have the cylindrical shapes having the axes. Further, the robot 2 has the plurality of fitting portions 521B-1, 521B-2 having different lengths of axes from each other. In other words, the robot 2 has the plurality of fitting portions 521B-1, 521B-2 having the different lengths in the direction in which the fitting portions 521B-1, 521B-2 are fitted in the fitted portions 551B-1, 551B-2.

According to the above described configuration, for example, when a load that pivots the fitting portions 521B-1, 521B-2 is applied to the fitted portions 551B-1, 551B-2 about the Y-axis, idle rotation may be prevented. Further, the cylindrical fitting portions 521B-1, 521B-2 respectively have the shapes easy for fitting work, the time taken for tool replacement may be shortened.

As above, the robot system and tool replacement method according to the present disclosure are explained based on the illustrated embodiments, however, the present disclosure is not limited to these embodiments.

For example, in the robot system according to the present disclosure, the configurations of the respective parts of the above described embodiments may be replaced by arbitrary configurations having the same functions, or arbitrary configurations may be added to the above described embodiments. Further, the robot system according to the present disclosure may be formed by a combination of the above described plurality of embodiments.

In the tool replacement method according to the present disclosure, steps for arbitrary purposes may be added to the above described embodiments. Further, in the tool replacement method according to the present disclosure, the sequence of the steps of the above described embodiments may be changed.

What is claimed is:

1. A robot system comprising:
a robot including a robot arm, a force sensor provided in the robot arm, and a fitted portion provided at an opposite side to the robot arm via the force sensor;
a tool having a fitting portion fitting in the fitted portion; and
a control apparatus controlling actuation of the robot, wherein
the control apparatus performs
first control to detach the tool from the robot arm by driving the robot arm based on output of the force sensor and releasing fitting of the fitted portion and the fitting portion, and
second control to attach the tool to the robot arm by driving the robot arm based on the output of the force sensor and fitting the fitted portion in the fitting portion.

2. The robot system according to claim 1, wherein
a section shape of the fitting portion cut along a plane having a normal along an axis in a direction in which the fitting portion is fitted in the fitted portion is a polygonal shape or elliptical shape.

3. The robot system according to claim 1, wherein
the fitting portion has a cylindrical shape, and
the robot has a plurality of the fitting portions having different lengths in a direction in which the fitting portion is fitted in the fitted portion.

4. The robot system according to claim 1, wherein
the robot includes an attraction mechanism attracted to the fitting portion or an engagement mechanism engaged with the fitting portion provided in the fitted portion.

5. The robot system according to claim 1, wherein
the fitted portion includes a tapered portion having a tapered shape that guides and fits the fitting portion.

6. The robot system according to claim 1, further comprising a holder that holds the tool, wherein
the control apparatus releases fitting of the fitting portion and the fitted portion by driving the robot arm based on the output of the force sensor to control the holder to hold the tool in the first control.

7. The robot system according to claim 6, wherein
the holder includes an engagement portion that engages and holds the tool, and
in the first control, a first movement direction of the fitted portion when the tool is engaged with the engagement portion and a second movement direction of the fitted portion when fitting of the fitting portion and the fitted portion is released are non-parallel.

8. A tool replacement method in a robot system including
a robot including a robot arm, a force sensor provided in the robot arm, and a fitted portion provided at an opposite side to the robot arm via the force sensor,
a tool having a fitting portion fitting in the fitted portion, and
a control apparatus controlling actuation of the robot, the tool replacement method comprising:
detaching, under the control by the central apparatus, the tool from the robot arm by driving the robot arm based on output of the force sensor and releasing fitting of the fitted portion and the fitting portion; and
attaching, under the control by the central apparatus, the tool to the robot arm by driving the robot arm based on the output of the force sensor and fitting the fitted portion in the fitting portion.
